(19) United States
(12) Patent Application Publication
(10) Pub. No.: US 2009/0104053 A1
(43) Pub. Date: Apr. 23, 2009

(54) Fan Unit and Methods of Forming Same

(75) Inventor: John P. Franz, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/344,111

(22) Filed: Dec. 24, 2008

Related U.S. Application Data
(62) Division of application No. 10/827,965, filed on Apr. 19, 2004.

(51) Int. Cl. F04D 29/26; F04D 25/06; B23P 11/00

(52) U.S. Cl. 417/354; 416/175; 29/888.025

(57) ABSTRACT

The described embodiments relate to fans units. One exemplary fan unit includes a housing supporting a motor. The fan unit also includes an impeller coupled to the motor and configured to be rotated by the motor. The impeller comprises at least a first structure configured to move air past the housing and at least one second different structure configured to force air into the housing

### RELATED APPLICATIONS

This patent application claims priority to U.S. patent application Ser. No. 10/827,965, titled “FAN UNIT AND METHODS OF FORMING SAME”, filed on 19 Apr. 2004, commonly assigned herewith, and hereby incorporated by reference.

### BACKGROUND

Fan units are employed for creating air movement in many diverse environments. A fan unit can create air movement when an electric motor imparts mechanical energy to one or more fan blades. The electric motor generates heat that can affect a lifespan of the fan unit. Fan units are often employed in heated ambient environments which can exacerbate the heat issues of the fan unit.

### BRIEF DESCRIPTION OF THE DRAWINGS

The same numbers are used throughout the drawings to reference like features and components wherever feasible.

FIG. 1a illustrates a perspective view of an exemplary fan unit in accordance with one embodiment of the inventive concepts.

FIG. 1b illustrates a cross-sectional view of an exemplary fan unit in accordance with one embodiment of the inventive concepts.

FIG. 1c illustrates a cross-sectional view of a portion of the exemplary fan unit illustrated in FIG. 1b in accordance with one embodiment.

FIG. 1d illustrates a perspective view of a portion of the exemplary fan unit illustrated in FIG. 1a in accordance with one embodiment.

FIG. 1e illustrates a front elevational view of a portion of the exemplary fan unit illustrated in FIG. 1a in accordance with one embodiment.

FIGS. 2-3 illustrate front elevational views of a portion of exemplary fan units in accordance with one embodiment of the inventive concepts.

FIG. 4 illustrates a perspective view of an exemplary fan unit in accordance with one embodiment of the inventive concepts.

FIG. 5a illustrates a perspective view of an exemplary fan unit in accordance with one embodiment of the inventive concepts.

FIG. 5b illustrates a cross-sectional view of an exemplary fan unit in accordance with one embodiment of the inventive concepts.

FIG. 6a illustrates a perspective view of an exemplary fan unit in accordance with one embodiment of the inventive concepts.

FIG. 6b illustrates a cross-sectional view of an exemplary fan unit in accordance with one embodiment of the inventive concepts.

FIG. 7a illustrates a perspective view of an exemplary computer system in accordance with one embodiment of the inventive concepts.

FIG. 7b illustrates a cross-sectional view of an exemplary computer system in accordance with one embodiment of the inventive concepts.

### DETAILED DESCRIPTION

### Overview

The described embodiments relate to fan units having a means for cooling an internal environment of the fan unit. The fan units can comprise a housing and an impeller configured to rotate relative to the housing. The housing can define the internal environment or internal volume. The housing can support various electrical components, such as a motor, within the internal volume. The motor can provide the mechanical energy to rotate the impeller to create air movement around the housing. The impeller can also be configured to force air into, and through, the internal environment to increase heat dissipation of the internal environment.

Exemplary fan units can be employed in various applications. One such application positions a fan unit in or on a consumer device such a computer, server, printer or other device having electrical components which generate heat. The fan unit can be positioned within a housing of the consumer device to cool the consumer device by moving air through the consumer device. In such an implementation, the fan unit operates in a heated ambient environment within the consumer device.

### Exemplary Embodiments

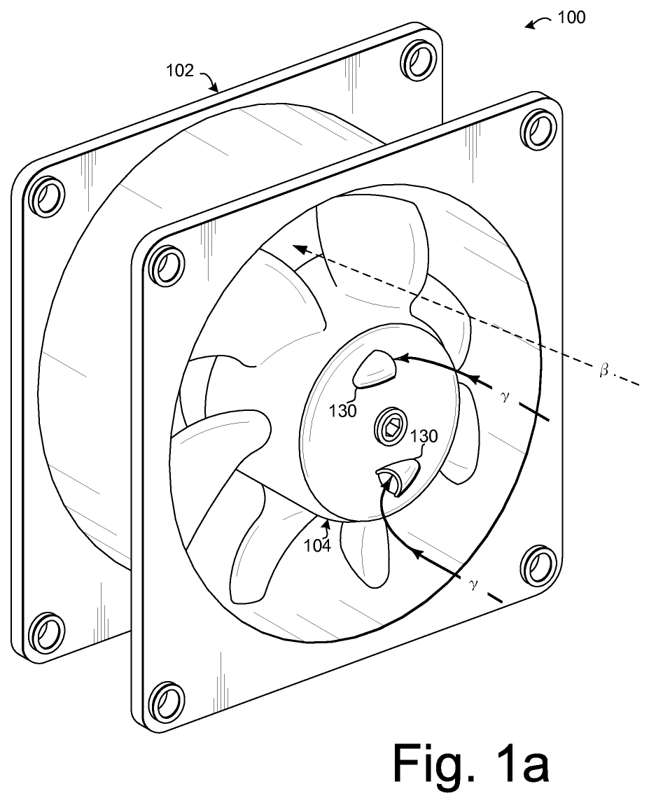

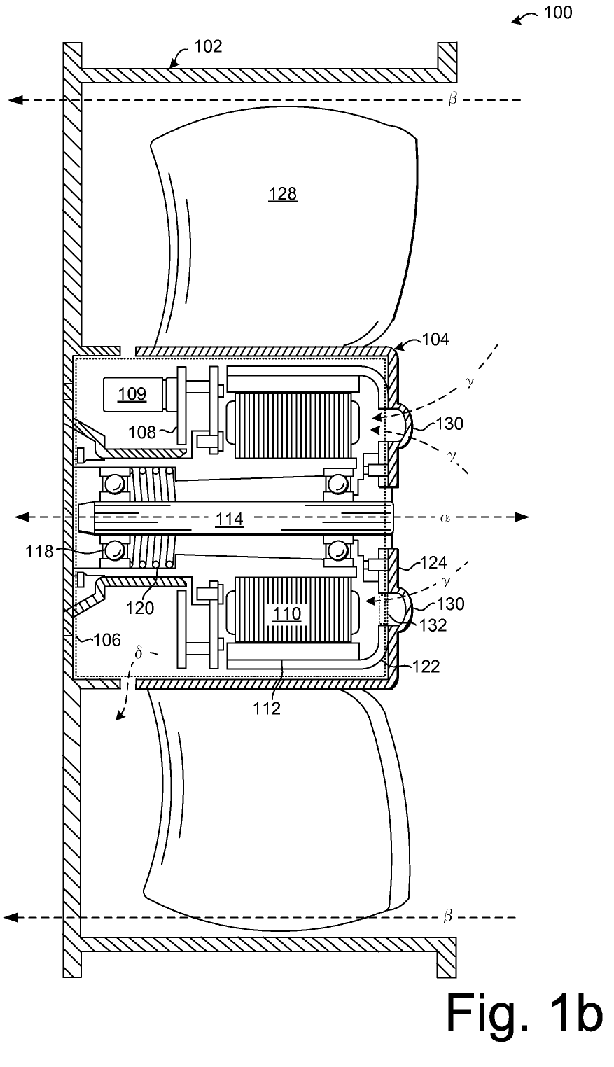

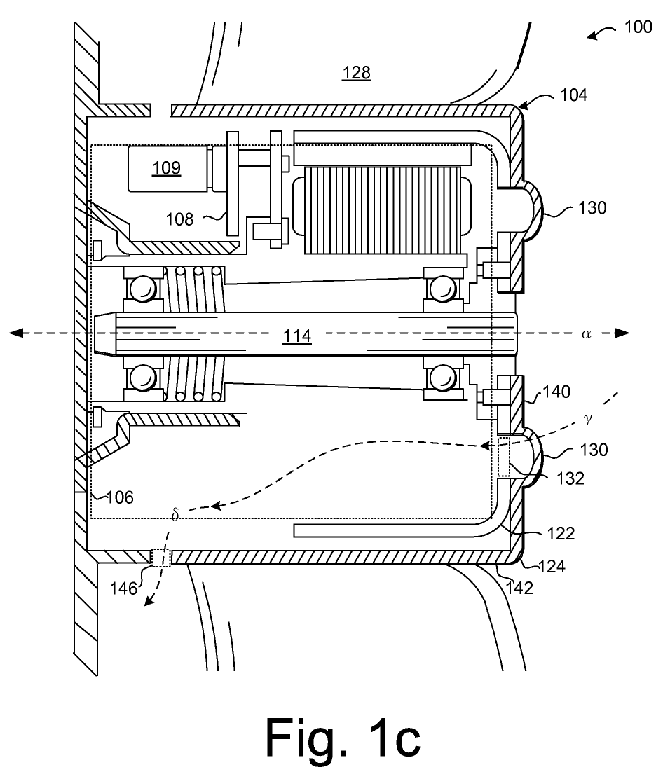

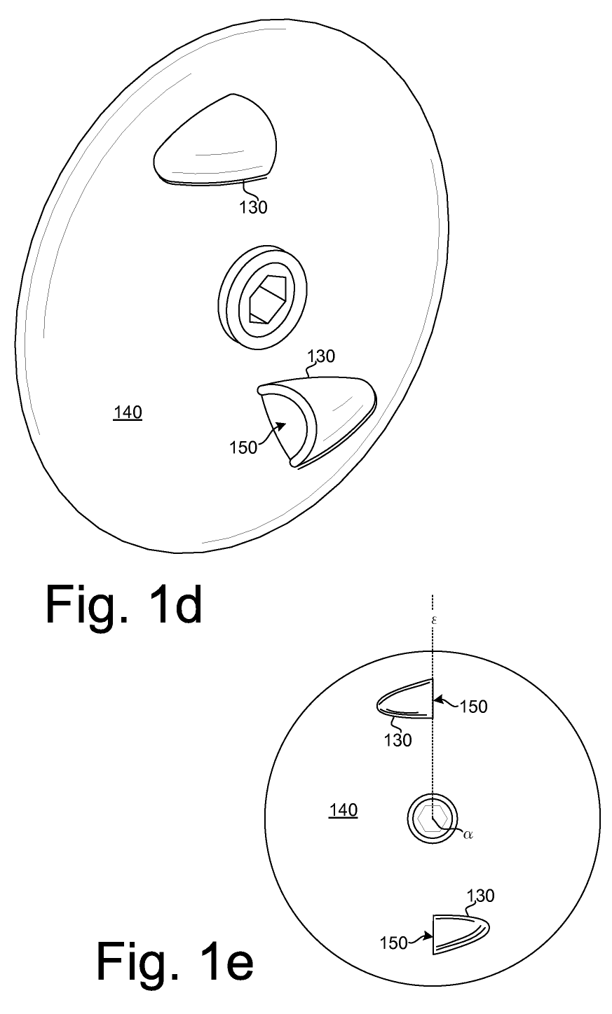

FIGS. 1a-1b illustrate perspective and cross-sectional views respectively of an exemplary fan unit 100. This particular fan unit comprises a housing 102 and an impeller 104. Housing 102 supports various electrical components in an internal volume or environment indicated generally at 106. In this particular embodiment, examples of the various components supported by housing 102 can include a circuit board 108, a capacitor 109, a motor coil 110 and a motor magnet 112 among others. Circuit board 108 contains power regulators and control logic to the motor coil 110 and motor magnet 112 which drive a shaft 114. Bearings 118 support shaft 114. A spring 120 can absorb thrust from, and/or associated with, the shaft movement and maintain the shaft in a proper orientation. This is but one suitable motor means for imparting mechanical energy to the impeller. The skilled artisan should recognize other configurations.

Shaft 114 is coupled to a cup 122 which is coupled to impeller 104. The impeller comprises a hub 124 and a first structure configured to move air past housing 102. In this particular embodiment the first structure comprises multiple blades 128 extending radially from hub 124. The hub also has a second structure configured to force air into internal volume 106. In this embodiment the second structure comprises one or more scoops 130.

During operation, electrical energy can be supplied to circuit board 108. Motor coil 110 and motor magnet 112 can convert the electrical energy into mechanical energy that drive impeller 104. Circuit board 108, motor coil 110, motor magnet 112, and bearings 118 generate heat during operation. Heat production within the internal volume increases as the fan unit is operated at increasing revolutions per minute of the shaft/impeller.

Impeller 104 surrounds a portion of internal volume 106 such that with existing designs air movement from blades 128 does not generally enter internal volume 106 and as such does not provide a significant heat dissipation capacity. Further, the impeller may act as a thermal insulator which slows heat dissipation from internal volume 106. For example, impeller 104 can be constructed of various materials such as polymers, metals and composites. These materials can have a relatively low rate of heat dissipation, due at least in part, to their low thermal conductivity. Thus, existing designs can impede heat dissipation by blocking airflow through the internal volume and/or by surrounding some of the internal volume with a generally thermally-insulative material. The present embodiments can increase heat dissipation by forcing air into the internal volume through scoops 130. These embodiments allow increased heat dissipation regardless of the impeller composition. As such, the present embodiments can allow an impeller material to be selected based upon various factors such as cost and weight without concern for the thermal dissipation properties of the material. Alternatively or additionally, scoops 130 can provide increased airflow through the internal volume with increasing impeller revolution. Thus, the cooling capacity automatically increases with increased RPM and associated heat output. Though the description above relates to utilizing a single material to form the impeller it is equally applicable to other configurations. For example, the hub 124 could be formed from a first material, such as metal, which is joined to blades 128 formed from a second material, such as a polymer. Impeller 104 can be formed utilizing known processes such as injection molding.

In operation of the illustrated embodiment, impeller 104 can rotate around an axis of rotation α which passes through shaft 114. Rotation of impeller's blades 128 can create air movement past housing 102 as indicated generally by arrows β. Rotation of impeller 104 also causes scoops 130 to force air into internal volume 108 as indicated generally by arrows γ. Scoops 130 force air into the internal volume through respectively aligned holes 132 formed in cup 124. Air in internal volume 106 can exit through an exit space which will be described in more detail below. Air leaving the internal volume is indicated here generally by arrow δ.

The reader is now referred to FIG. 1c in combination with FIGS. 1a-1b. FIG. 1c illustrates a representation of a portion of fan unit 100. FIG. 1c is a cross-sectional view similar to that illustrated in FIG. 1b with some of the internal components of the fan unit removed for purposes of explanation. In this embodiment, hub 124 has a first surface 140 extending generally transverse to axis of rotation α and a second surface 142 which is generally parallel to the axis of rotation. In this embodiment, scoops 130 are formed in first surface 140 so that upon rotation, air can enter the scoops and pass through corresponding holes 132 to enter internal cavity 106. The air can then leave the internal cavity through an exit hole or space 146. In this instance the exit hole comprises a gap between impeller 104 and housing 102. Examples of other configuration are described below.

FIGS. 1d-1e illustrate a representation of a perspective view and a front elevational view respectively, of the first surface 140 of the hub. In this embodiment, individual scoops 130 approximate a conoid that defines an opening 150. The opening is oriented generally radially relative to the hub's axis of rotation α such that air enters the opening generally orthogonally to axis α. In FIG. 1e the axis of rotation extends into and out of the page on which the figure appears. In this particular embodiment, the scoops are oriented along axis α such that each scoop is an inverse symmetrical relation to the other. A radial axis ε is provided in FIG. 1e for purposes of explanation. Examples of other scoop configurations are provided below.

The relative size of scoop openings 150 can be selected based upon various factors. For example, such factors may include the intended RPM of the fan unit, the intended ambient operating environment temperature of the fan unit, the number of scoops employed, among others. In some examples, the combined area of openings 150 can comprise approximately 5% to 50% of the surface area of first surface 140. In still other examples the combined openings can comprise approximately 10% to approximately 25% of the surface area of first surface 140.

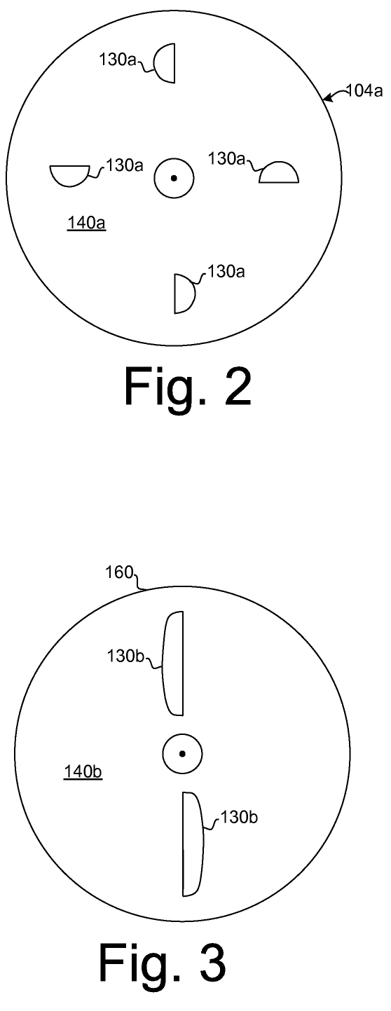

FIGS. 2-3 illustrate further examples of scoop configurations formed on a hub's first surface. FIG. 2 illustrates four generally hemispherical scoops 130a formed on first surface 140a of hub 104a. Similarly, FIG. 3 illustrates two scoops 130b which are relatively elongated between the axis of rotation α and an outer edge 160 of first surface 140b.

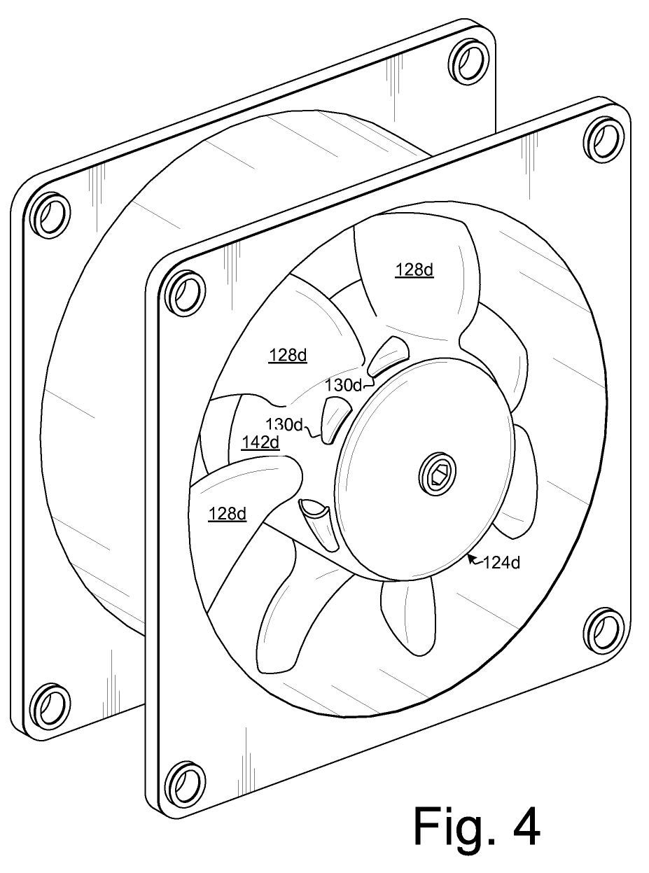

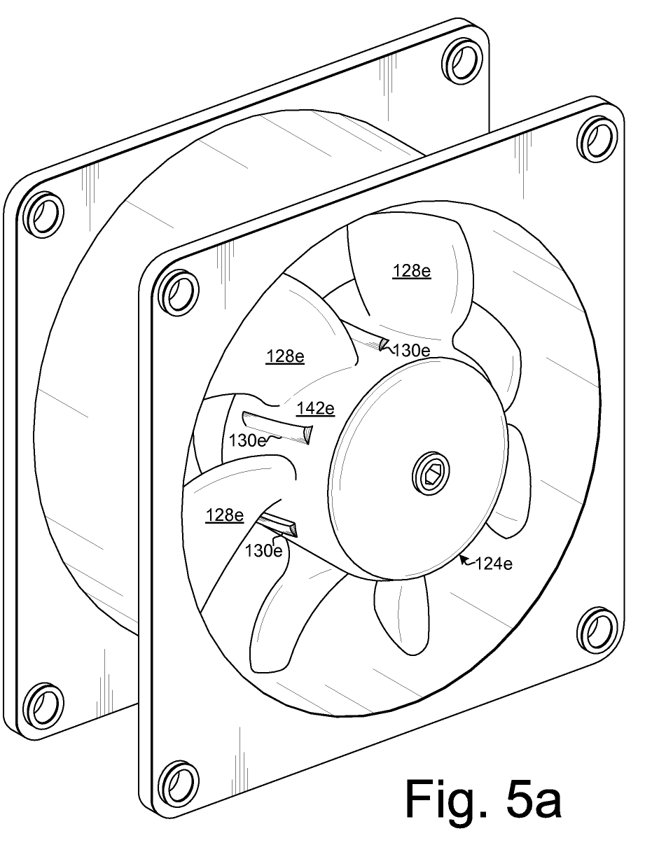

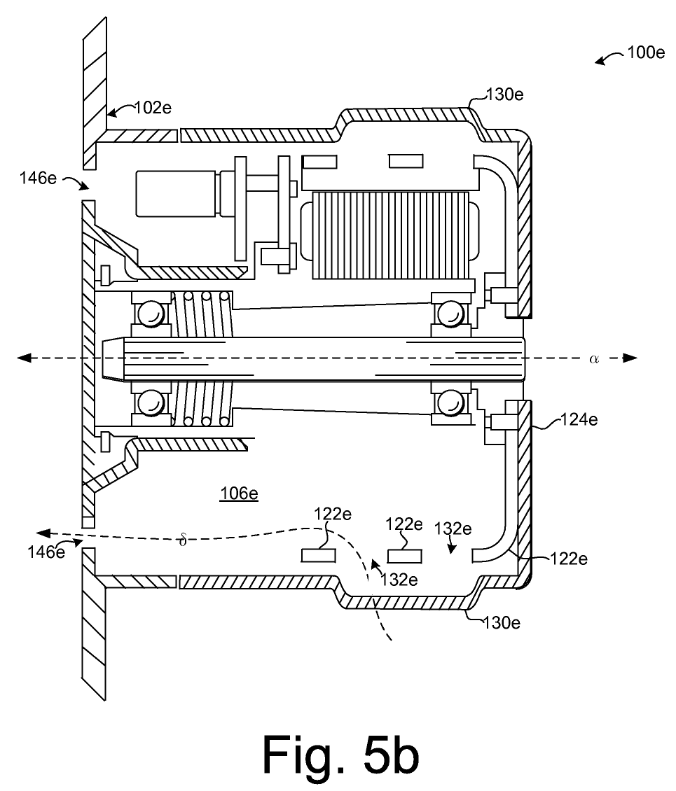

FIGS. 4 and 5a illustrate perspective representations of additional exemplary fan unit configurations. In these embodiments, the impeller hub has multiple blades as well as multiple scoops positioned on the hub's second surface. In FIG. 4, hub 124d has multiple blades 128d and multiple scoops 130d positioned on second surface 142e. Similarly in FIG. 5a, hub 124e has multiple blades 128e and multiple scoops 130e positioned on second surface 142e. The scoops can force air into the fan unit's internal volume as can be evidenced from FIG. 5b.

FIG. 5b illustrates a cross-sectional view of fan unit 100e similar to that illustrated in FIG. 1c. Scoop 130e is respectively aligned with holes 132e in cup 122e so that rotation of impeller 104e forces air into internal volume 106e. In this embodiment, the air can leave the internal volume through exit opening 146e formed in housing 102e. While the embodiments described above position scoops on either the first or second hub surfaces, other embodiment may position scoops on both the first and second surfaces.

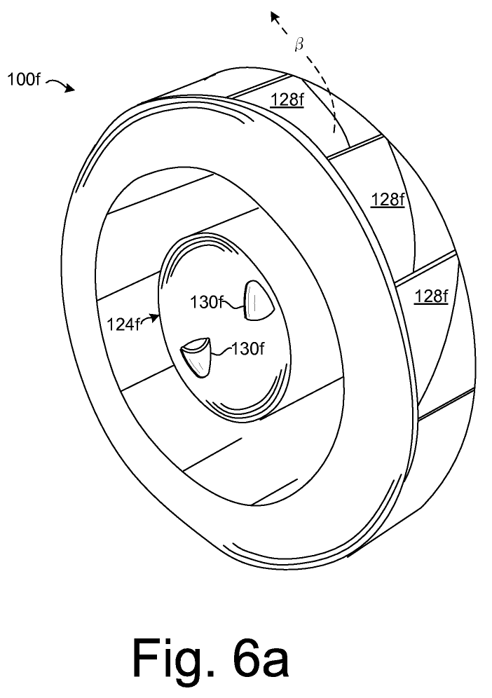

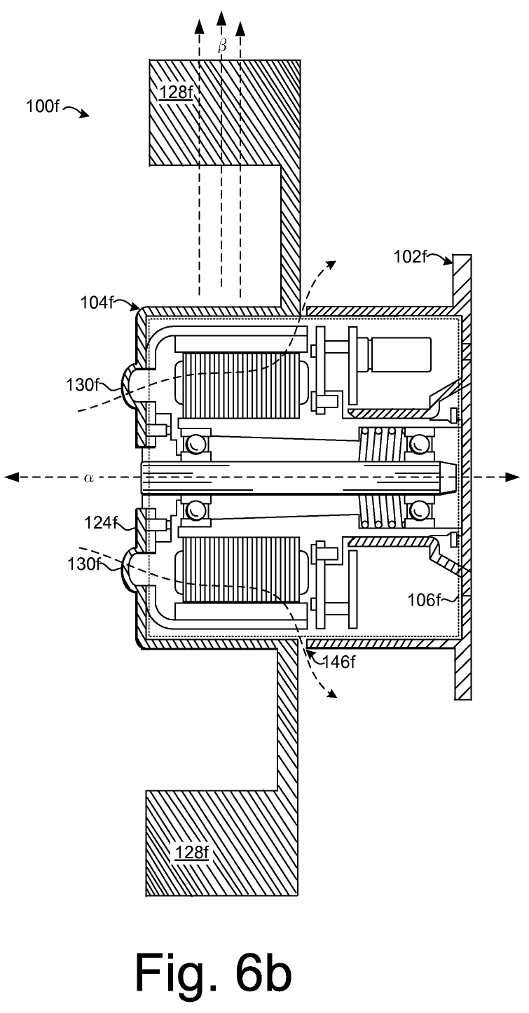

FIGS. 6a-6b illustrate another exemplary fan unit 100f. FIG. 6a represents a perspective view while FIG. 6b illustrates a cross-sectional view taken parallel to an intersecting the fan units axis of rotation. In this embodiment, rotation of hub 124f around axis of rotation α causes blades 128f to move air generally outwardly and away from the axis of rotation as indicated generally by arrows β. Scoops 130f force air into the internal volume 106f. Air can leave the internal volume via exit opening 146f between impeller 104f and housing 102f

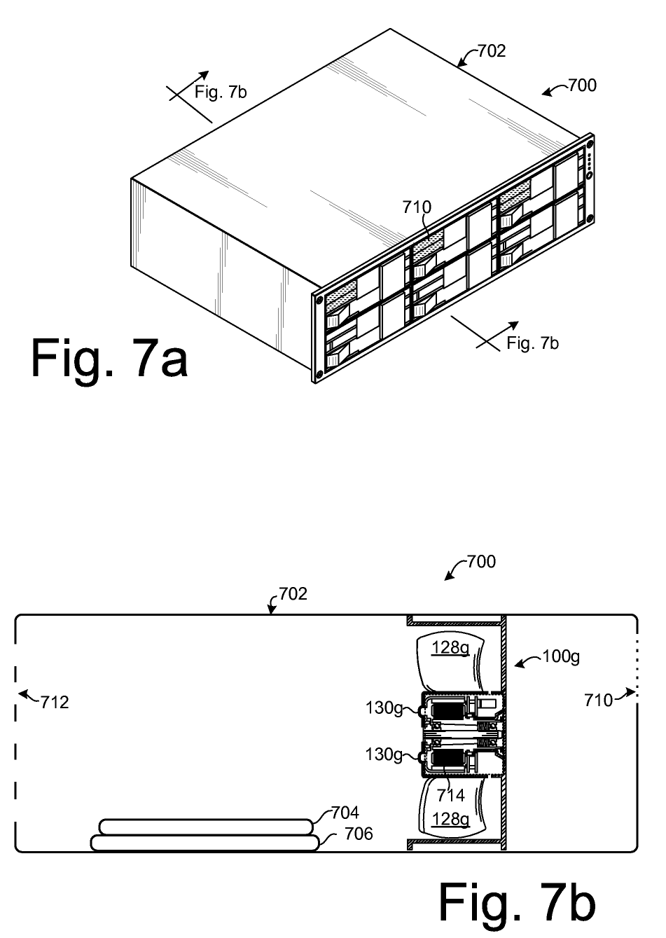

FIGS. 7a-7b illustrate an exemplary system 700 embodied as a consumer device. FIG. 7a represents a perspective view while FIG. 7b illustrates a cross-sectional view as indicated in FIG. 7a. A consumer device is any device which can be purchased for personal and/or business use. In this embodiment the consumer device comprises a computing device in the form of a server. Other computing devices can include personal computers, both desktop and notebook versions.

System 700 comprises a chassis 702 supporting at least one electrical component. In this particular embodiment the electrical components comprise a processor 704 coupled to a printed circuit board 706. This is but one example of electrical components that can be supported by chassis 702. Other electrical components can range from transistors and resistors to hard drives and digital versatile disk players/recorders. In this embodiment, chassis 702 has ventilation areas 710, 712 formed at generally opposing ends of the chassis to allow air movement through the chassis. This is but one suitable configuration; the skilled artisan should recognize many other chassis configurations. Fan unit 100g is positioned proximate chassis 702 to create air movement within and/or through the chassis by means of blades 128g. In this particular embodiment, fan unit 100g is positioned within the chassis 702, but other configurations may also allow the fan unit to be positioned outside the chassis. For example, the fan unit could be positioned outside of chassis 702 but proximate to ventilation area 712 sufficiently to create air movement within the chassis.

Operating temperatures within chassis 702 may be above those of the ambient environment. Such elevated temperature can be due, at least in part, to heat generation from processor 704 and/or printed circuit board 706. When the fan unit's motor, indicated generally at 714, functions to turn blades 128g, the motor generates heat which may not be easily dissipated away from the motor due, at least in part, to the elevated temperatures. Scoops 130g are configured to force air past motor 714. As such, the scoops can provide heat dissipation to the motor.

### CONCLUSION

The described embodiments relate to fan units having a means for cooling an internal environment of the fan unit. The fan units can comprise a housing and an impeller configured to move relative to the housing. The housing can define the internal environment or internal volume containing the fan motor. The impeller can have a first structure, such as a blade, configured to move air past the housing and a second different structure, such as a scoop, configured to force air into, and through, the internal environment to increase heat dissipation of the internal environment.

Although the inventive concepts have been described in language specific to structural features and/or methodological steps, it is to be understood that the inventive concepts in the appended claims are not limited to the specific features or steps described. Rather, the specific features and steps are disclosed as forms of implementing the inventive concepts.

1. A fan unit comprising:
a housing defining an internal volume and supporting a motor in the internal volume; and,
an impeller coupled to the motor and configured to rotate in relation to the housing, wherein the impeller comprises at least one first structure configured to move air past the housing and at least one second different structure configured to force air into the internal volume.

2. The fan unit as recited in claim 1, wherein the impeller comprises a hub and the first structure, and wherein the first structure comprises multiple blades joined with and extending from the hub.

3. The fan unit as recited in claim 2, wherein the motor comprises a shaft that is coupled to the hub, and wherein the impeller revolves around an axis of rotation generally defined by the shaft, and wherein the hub comprises at least a first surface extending generally transverse the axis of rotation and at least a second surface extending generally parallel to the axis of rotation and wherein the at least one second different structure is formed on the second surface.

4. The fan unit as recited in claim 2, wherein the motor comprises a shaft that is coupled to the hub, and wherein the impeller revolves around an axis of rotation generally defined by the shaft, and wherein the hub comprises at least a first surface extending generally transverse the axis of rotation and at least a second surface extending generally parallel to the axis of rotation and wherein the at least one second different structure is formed on the first surface.

5. The fan unit as recited in claim 4, wherein the at least one second different structure defines an opening that is radially oriented relative to the axis of rotation.

6. The fan unit as recited in claim 4, wherein the at least one second different structure comprises multiple different structures.

7. The fan unit as recited in claim 4, wherein the at least one second different structure is generally hemispherical.

8. The fan unit as recited in claim 4, wherein the at least a second different structure comprises a conoid.

9. The fan unit as recited in claim 1, wherein the motor comprises a shaft and a cup attached to the shaft, and wherein the impeller is coupled to the cup, and wherein the cup has at least one hole formed therein which is respectively aligned with said at least one second different structure.

10. The fan unit as recited in claim 1, wherein the at least one second different structure comprises a scoop.

11. The fan unit as recited in claim 10, wherein the scoop comprises a conoid.

12. A consumer device embodying the fan unit of claim 1.

13. An impeller comprising:
a hub configured to be rotated by a motor;
a first structure coupled to the hub and configured to move air past the hub; and,
a second different structure configured to force air into the hub when the hub is rotated.

14. A system comprising:
an impeller;
a means on the impeller for moving air along the outside of the impeller when the impeller is rotated; and,
a means on the impeller for moving air within a structure on which the impeller can be mounted.

15. A method comprising:
forming a first structure of an impeller, the impeller configured to be positioned about a housing, the first structure configured to move air past the housing when the impeller is rotated relative to the housing; and,
forming a second structure of the impeller configured to force air into the housing when the impeller is rotated relative to the housing.

16. The method as recited in claim 15, wherein the acts of forming comprise molding.

17. A method comprising:
positioning an impeller relative to a housing, the housing containing a motor for driving a shaft; and,
coupling the impeller to the shaft such that a first structure of the impeller is configured to move air past the housing when the impeller is rotated relative to the housing and a second structure of the impeller is configured to move air into the housing.

18. The method as recited in claim 17, wherein the act of positioning comprises aligning the impeller with a cup attached to the shaft such that a hole in the cup is respectively aligned with the second structure.

19. A fan unit operating method comprising:
rotating an impeller relative to a housing, the housing containing a motor for driving a shaft;
moving air past the impeller; and,
moving air through the impeller and past the motor.
